(19) United States
(12) Patent Application Publication
(10) Pub. No.: US 2011/0116894 A1
(43) Pub. Date: May 19, 2011

(54) Self-Tapping Screw

(76) Inventor: Yung-Chi Huang, Fengshan City (TW)

(21) Appl. No.: 12/621,668

(22) Filed: Nov. 19, 2009

(51) Int. Cl. F16B 25/10

(52) U.S. Cl. 411/387.4

(57) ABSTRACT

A self-tapping screw includes a threaded shank, a drill bit and a head. The drill bit is provided with two blades each provided with at least one cutting slot. Thus, the cutting slot of each of the two blades performs a cutting action during the tapping process to aid the tapping action of the two blades so as to increase the self-tapping velocity of the blades and to shorten the working time of the drill bit. In addition, the cutting slot of each of the two blades can proceed the cutting and tapping action to prevent the drill bit from being inoperative when the two blades are broken or worn out during a long-term utilization so as to enhance the lifetime of the self-tapping screw.

### BACKGROUND OF THE INVENTION

1. Field of the Invention

The present invention relates to a screw and, more particularly, to a self-tapping screw.

2. Description of the Related Art

A conventional self-tapping screw in accordance with the prior art shown in FIG. 4 comprises a threaded shank 11 and a drill bit 12 mounted on an end portion of the threaded shank 11. The drill bit 12 is provided with two blades 121 and two chip draining grooves 122 each connected to one of the two blades 121. In operation, the two blades 121 of the drill bit 12 are rotated to perform a start tapping and cutting action so as to form a drill hole on a workpiece, such as a metallic plate, steel frame and the like. At this time, the two chip draining grooves 122 can be used to drain the chips removed from the workpiece during the tapping process of the two blades 121. Then, the threaded shank 11 can be screwed into the drill hole of the workpiece so that the self-tapping screw is screwed into the workpiece. However, when the two blades 121 of the drill bit 12 are broken or worn out during the start tapping or cutting action, the drill bit 12 is inoperative, thereby failing the self-tapping screw.

### BRIEF SUMMARY OF THE INVENTION

In accordance with the present invention, there is provided a self-tapping screw, comprising a threaded shank, a drill bit mounted on a first end of the threaded shank and a head mounted on a second end of the threaded shank. The drill bit is provided with two blades. Each of the two blades of the drill bit is provided with at least one cutting slot. Each of the two blades of the drill bit has a rear portion provided with a smooth back face and a chip draining groove. Preferably, the at least one cutting slot of each of the two blades is formed on the back face of each of the two blades. The at least one cutting slot of each of the two blades is provided with an acute cutting edge and a chip receiving recess.

The primary objective of the present invention is to provide a self-tapping screw having a greater working efficiency.

According to the primary objective of the present invention, the at least one cutting slot of each of the two blades performs a cutting action during the tapping process to aid the tapping action of the two blades so as to increase the self-tapping velocity and efficiency of the two blades and to shorten the working time of the drill bit.

According to another objective of the present invention, the at least one cutting slot of each of the two blades can proceed the cutting and tapping action to prevent the drill bit from being inoperative when the two blades are broken or worn out during a long-term utilization so as to enhance the lifetime of the self-tapping screw.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a self-tapping screw in accordance with the preferred embodiment of the present invention.

FIG. 2 is a partially top view of the self-tapping screw as shown in FIG. 1.

FIG. 3 is a front view of the self-tapping screw as shown in FIG. 1.

FIG. 4 is a top view of a conventional self-tapping screw in accordance with the prior art.

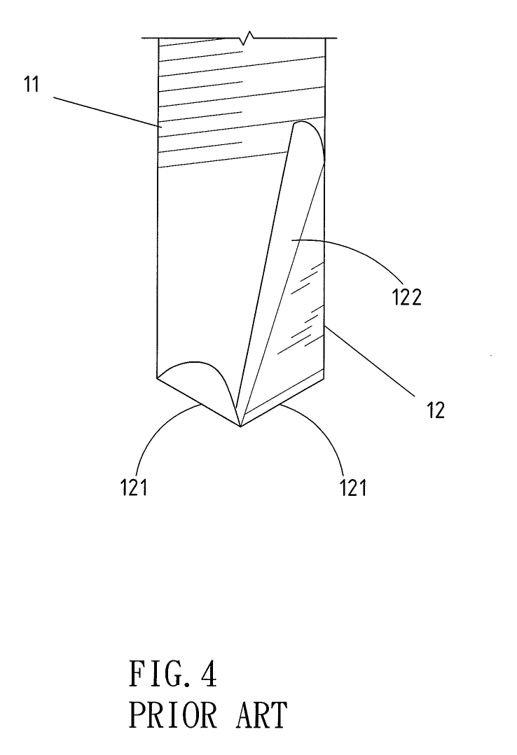

### DETAILED DESCRIPTION OF THE INVENTION

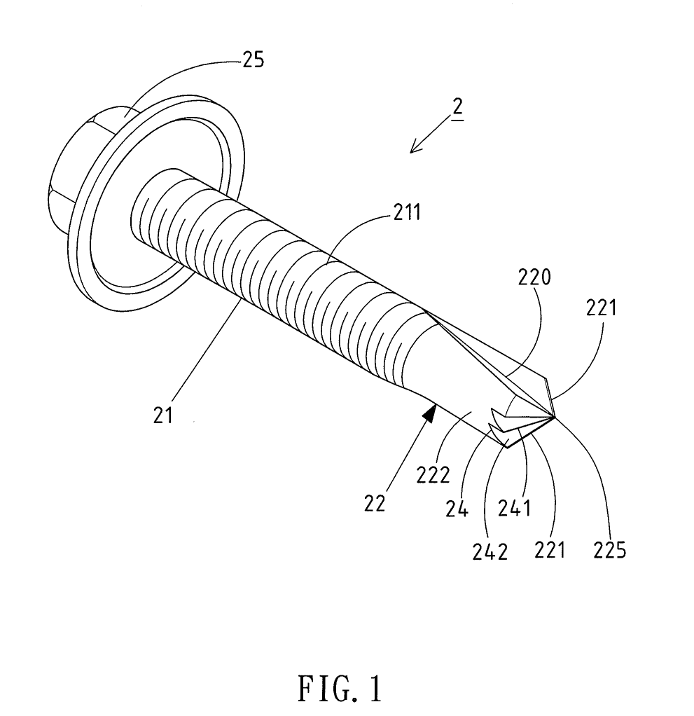

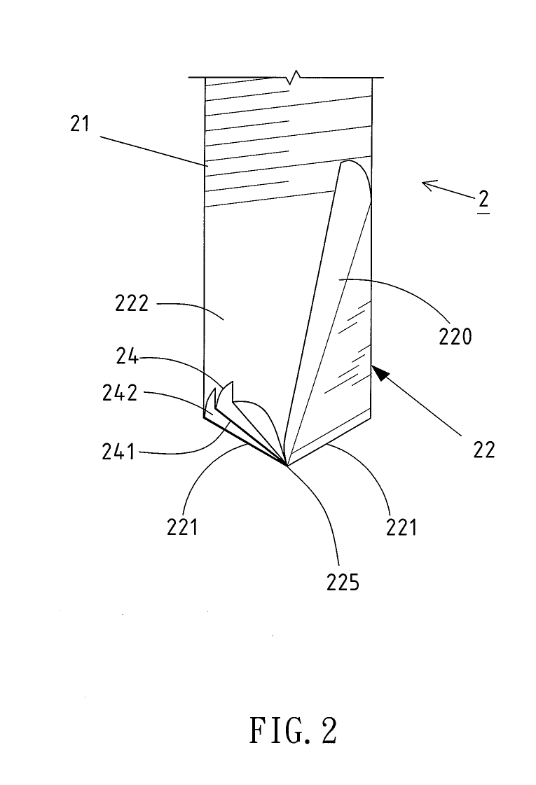

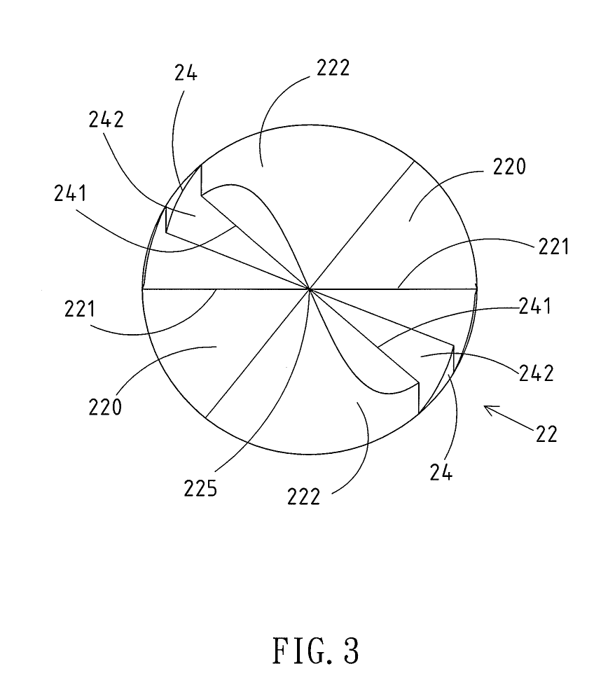

Referring to FIGS. 1-3, a self-tapping screw 2 in accordance with the preferred embodiment of the present invention comprises a threaded shank 21, a drill bit 22 mounted on a first end of the threaded shank 21, and a head 25 mounted on a second end of the threaded shank 21.

The threaded shank 21 has a periphery formed with an outer thread 211. The outer thread 211 of the threaded shank 21 is located between the drill bit 22 and the head 25.

The drill bit 22 is coaxial with the threaded shank 21 and has a central point 225 that is coaxial with a central point of the threaded shank 21. The drill bit 22 is provided with two blades 221. The two blades 221 of the drill bit 22 are arranged symmetrically about the central point 225 of the drill bit 22. The two blades 221 of the drill bit 22 are rotated in the screwing direction of the outer thread 211 of the threaded shank 21 to perform a cutting action.

Each of the two blades 221 of the drill bit 22 is provided with at least one cutting slot 24. Each of the two blades 221 of the drill bit 22 has a rear portion provided with a smooth back face 222 and a chip draining groove 220. The back faces 222 of the two blades 221 are arranged symmetrically about the central point 225 of the drill bit 22, and the chip draining grooves 220 of the two blades 221 are arranged symmetrically about the central point 225 of the drill bit 22. The at least one cutting slot 24 of each of the two blades 221 is formed on the back face 222 of each of the two blades 221. The cutting slots 24 of the two blades 221 are arranged symmetrically about the central point 225 of the drill bit 22. The at least one cutting slot 24 of each of the two blades 221 is provided with an acute cutting edge 241 and a chip receiving recess 242. The cutting edges 241 of the two blades 221 are arranged symmetrically about the central point 225 of the drill bit 22. The back face 222 of each of the two blades 221 is located between the at least one cutting slot 24 and the outer thread 211 of the threaded shank 21.

In operation, the two blades 221 of the drill bit 22 are rotated about the central point 225 of the drill bit 22 to perform a start tapping and cutting action so as to form a drill hole on a workpiece, such as a metallic plate and the like. After the drill bit 22 is slightly drilled into the workpiece, the at least one cutting slot 24 of each of the two blades 221 also performs a cutting action during the tapping process so as to increase the self-tapping velocity and efficiency of the two blades 221 and to shorten the working time of the drill bit 22.

Accordingly, the at least one cutting slot 24 of each of the two blades 221 performs a cutting action during the tapping process to aid the tapping action of the two blades 221 so as to increase the self-tapping velocity and efficiency of the two blades 221 and to shorten the working time of the drill bit 22. In addition, the at least one cutting slot 24 of each of the two blades 221 can proceed the cutting and tapping action to prevent the drill bit 22 from being inoperative when the two blades 221 are broken or worn out during a long-term utilization so as to enhance the lifetime of the self-tapping screw 2.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A self-tapping screw, comprising:
a threaded shank;
a drill bit mounted on a first end of the threaded shank;
a head mounted on a second end of the threaded shank;
wherein the drill bit is provided with two blades;
each of the two blades of the drill bit is provided with at least one cutting slot.

2. The self-tapping screw of claim 1, wherein
each of the two blades of the drill bit has a rear portion provided with a smooth back face and a chip draining groove;
the at least one cutting slot of each of the two blades is formed on the back face of each of the two blades.

3. The self-tapping screw of claim 2, wherein the at least one cutting slot of each of the two blades is provided with an acute cutting edge and a chip receiving recess.

4. The self-tapping screw of claim 3, wherein the drill bit has a central point.

5. The self-tapping screw of claim 4, wherein the two blades of the drill bit are arranged symmetrically about the central point of the drill bit.

6. The self-tapping screw of claim 4, wherein the back faces of the two blades are arranged symmetrically about the central point of the drill bit.

7. The self-tapping screw of claim 4, wherein the chip draining grooves of the two blades are arranged symmetrically about the central point of the drill bit.

8. The self-tapping screw of claim 4, wherein the cutting slots of the two blades are arranged symmetrically about the central point of the drill bit.

9. The self-tapping screw of claim 4, wherein the cutting edges of the two blades are arranged symmetrically about the central point of the drill bit.

10. The self-tapping screw of claim 2, wherein
the threaded shank has a periphery formed with an outer thread;
the back face of each of the two blades is located between the at least one cutting slot and the outer thread of the threaded shank.

11. The self-tapping screw of claim 1, wherein the drill bit is coaxial with the threaded shank.
